(19) United States
(12) Patent Application Publication
(10) Pub. No.: US 2015/0161435 A1
(43) Pub. Date: Jun. 11, 2015

(54) FRONTAL FACE DETECTION APPARATUS AND METHOD USING FACIAL POSE

(71) Applicant: ELECTRONICS AND TELECOMMUNICATIONS RESEARCH INSTITUTE, Daejeon-city (KR)

(72) Inventors: Sung-Uk JUNG, Daejeon (KR); Jang-Hee YOO, Daejeon (KR); So-Hee PARK, Daejeon (KR); Han-Sung LEE, Daejeon (KR)

(73) Assignee: ELECTRONICS AND TELECOMMUNICATIONS RESEARCH INSTITUTE, Daejeon-city (KR)

(21) Appl. No.: 14/523,976

(22) Filed: Oct. 27, 2014

(30) Foreign Application Priority Data
Dec. 5, 2013 (KR) 10-2013-0150783

(51) Int. Cl. G06K 9/00; G06K 9/52

(52) U.S. Cl. CPC G06K 9/00302; G06K 9/52

(57) ABSTRACT

Disclosed herein is a frontal face detection apparatus and method using a facial pose. The frontal face detection apparatus includes an image input unit for receiving an input image. A candidate extraction unit extracts a face region candidate and face element candidates from the input image. A face region verification unit verifies, based on a plurality of face element candidates extracted by the candidate extraction unit, whether the extracted face region candidate is a final face region. A face element calculation unit calculates a plurality of final face elements in correspondence with a facial pose score for a final face region including the extracted face element candidates generated based on a predefined average face model. A final frontal face detection unit detects a final frontal face from the final face region including the plurality of final face elements, based on a position pattern between the final face elements.

### CROSS REFERENCE TO RELATED APPLICATION

This application claims the benefit of Korean Patent Application No. 10-2013-0150783 filed Dec. 5, 2013, which is hereby incorporated by reference in its entirety into this application.

### BACKGROUND OF THE INVENTION

1. Technical Field

The present invention relates generally to frontal face detection technology and, more particularly, to a frontal face detection apparatus and method using a facial pose, which detect a face image from a captured image, extract facial feature points from the detected face image, estimate a face pose based on the extracted facial feature points, and then extract an optimal frontal face image easy for recognition from input images.

2. Description of the Related Art

Recently, application areas of face recognition technology have extended to fields such as entertainment and Customer Relationship Management (CRM) systems, as well as physical security fields such as access control and personal authentication. For example, such technology has been applied to entertainment fields which capture face images, acquire recognition information such as gender and age, and utilize the recognition information for advertising and marketing services, or which extract the facial features of a user, match the face of the user with that of entertainers having a similar face, or compare the features of respective faces with each other.

Most of the above-described face application systems are systems for determining a face based on two-dimensional (2D) images. However, since a face itself is a three-dimensional (3D) object, a face recognition rate is changed depending on the 3D pose (attitude) of the face.

Therefore, technology for detecting a frontal face is an important factor in face recognition. Most existing face detection systems use a Viola's AdaBoost-based face detection system.

Viola's method is a learning method based on statistical values, and is configured to extract a portion most similar, in probability, to learned data, rather than precisely extracting a face region and location. That is, depending on the environment, false detection may occur upon detecting a face, and thus correction of detected results is required.

Further, for a frontal face image suitable for recognition in video images, an image theoretically suitable for recognition is basically regarded as an image, in which a pose angle corresponding to the roll, pitch and yaw of the face is close to 0° in a 3D image, and which is closest to a camera. DeMenthon and Davis have extracted external parameters of a camera that was not calibrated using correlations between the locations of 3D feature points of an object and the locations of 2D feature points of the object.

That is, the rotation and movement information of objects was extracted from the standpoint of a camera. However, the above method is disadvantageous in that the 3D coordinates of virtual facial feature points are set and are caused to match the coordinates of facial feature points in a 2D image, and thus the angle of a pose may be erroneously estimated. Therefore, the supplementation of such erroneous estimation is required.

In another aspect, most face-related commercial systems are merely configured to detect a face using only Viola's face detector, and face recognition is performed based on the detected face image.

As described above, for a human face, systems have very different recognition rates depending on the pose angle of the face, and thus conventional systems recognize human faces by requiring a person to walk towards the camera or requiring the system to deduce the frontal face of a person. However, since this system does not use a frontal face image obtained by precisely measuring a facial pose, there is a variation in the recognition rate.

Therefore, in application systems that exploit face images, it may be essential to extract a frontal face image. Further, there is required a frontal face detection apparatus and method using a facial pose, which estimate the pose angle of a face detected from a captured image and extract an optimal frontal face image applicable to face recognition and application fields. Related technology is disclosed in Korean Patent Application Publication No. 2011-0006971.

### SUMMARY OF THE INVENTION

Accordingly, the present invention has been made keeping in mind the above problems occurring in the prior art, and an object of the present invention is to extract an optimal frontal face image easy for recognition from input images by detecting a face image from a captured image, extracting facial feature points from the detected face image, and estimating a face pose based on the extracted facial feature points.

Another object of the present invention is to examine the extraction results of face elements after a face has been detected, determine whether the face image is authentic, verify and correct the extracted face elements, and correct a facial pose after the facial pose has been estimated.

In accordance with an aspect of the present invention to accomplish the above objects, there is provided a frontal face detection apparatus using a facial pose, including an image input unit for receiving an input image, a candidate extraction unit for extracting a face region candidate and face element candidates from the input image, a face region verification unit for verifying, based on a plurality of face element candidates extracted by the candidate extraction unit, whether the extracted face region candidate is a final face region, a face element calculation unit for calculating a plurality of final face elements in correspondence with a facial pose score for a final face region including the plurality of extracted face element candidates generated based on a predefined average face model, and a final frontal face detection unit for detecting a final frontal face from the final face region including the plurality of final face elements, based on a position pattern between the final face elements.

The candidate extraction unit may include a face region candidate extraction unit for extracting a face region candidate depending on previously learned face detection data, and a face element candidate extraction unit for extracting face element candidates including a left eye, a right eye, a nose, and a mouth depending on previously learned face element detection data.

The face region verification unit may be configured to, when the face region candidate extracted by the candidate extraction unit includes a left eye, a right eye, a nose and a mouth, determine that the extracted face region candidate is a final face region, thus verifying the extracted face region candidate.

The face element calculation unit may include a score calculation unit for calculating a facial pose score for the final face region based on three-dimensional (3D) coordinates of each of the plurality of extracted face element candidates which are generated by matching a final face including the plurality of extracted face element candidates with a predefined average face model, and the facial pose score is a value obtained by assigning different weights to rotation angles of the final face region in directions of X, Y, and Z axes and a distance between the final face region and a camera, respectively, and summing up resulting values.

The face element calculation unit may include a first calculation unit for determining whether the facial pose score for the final face region has a value less than a predefined minimum score, and then firstly calculating the plurality of extracted face element candidates, included in the final face region, as final face elements if the facial pose score for the final face region has the value less than the predefined minimum score.

The face element calculation unit may further include a second calculation unit for determining whether a condition that a difference between a distance between a left eye and a nose and a distance between a right eye and the nose, among the final face elements firstly calculated by the first calculation unit, has a value less than a predefined difference is satisfied, and then secondly calculating the plurality of extracted face element candidates included in the final face region as final face elements.

The face element calculation unit may further include a third calculation unit for determining whether a condition that a difference between the distance between the left eye or right eye and the nose, among the final face elements secondly calculated by the second calculation unit, is greater than a distance between the nose and the mouth is satisfied, and then thirdly calculating the plurality of extracted face element candidates included in the final face region as final face elements.

The final frontal face detection unit may include a position pattern acquisition unit for projecting three-dimensional (3D) coordinates of each of the plurality of final face elements calculated by the face element calculation unit onto a 2D plane, and then acquiring a position pattern between the final face elements.

The final frontal face detection unit may further include a position pattern analysis unit for determining whether the position pattern acquired by the position pattern acquisition unit corresponds to a predefined reference pattern, and if the acquired position pattern corresponds to the reference pattern, detecting a final face region including the plurality of final face elements as a final frontal face.

The final frontal face detection unit may further include a reference pattern correction unit for, if the acquired position pattern does not correspond to the reference pattern, correcting the reference pattern by generating a new reference pattern, wherein the new reference pattern is different from the reference pattern and is generated by adding new face elements that are both corners of the mouth.

In accordance with another aspect of the present invention to accomplish the above objects, there is provided a frontal face detection method using a facial pose, including receiving, by an image input unit, an input image, extracting, by a candidate extraction unit, a face region candidate and face element candidates from the input image, verifying, by a face region verification unit, whether the extracted face region candidate is a final face region, based on a plurality of extracted face element candidates, calculating, by a face element calculation unit, a plurality of final face elements in correspondence with a facial pose score for a final face region including the plurality of extracted face element candidates generated based on a predefined average face model, and detecting, by a final frontal face detection unit, a final frontal face from the final face region including the plurality of final face elements, based on a position pattern between the final face elements.

Verifying whether the extracted face region candidate is the final face region may include, when the extracted face region candidate includes a left eye, a right eye, a nose and a mouth, determining that the extracted face region candidate is a final face region, thus verifying the extracted face region candidate.

Calculating the plurality of final face elements may include calculating, by a score calculation unit, a facial pose score for the final face region based on three-dimensional (3D) coordinates of each of the plurality of extracted face element candidates which are generated by matching a final face including the plurality of extracted face element candidates with a predefined average face model, and the facial pose score is a value obtained by assigning different weights to rotation angles of the final face region in directions of X, Y, and Z axes and a distance between the final face region and a camera, respectively, and summing up resulting values.

Calculating the plurality of final face elements may include determining, by a first calculation unit, whether the facial pose score for the final face region has a value less than a predefined minimum score, and then firstly calculating the plurality of extracted face element candidates, included in the final face region, as final face elements if the facial pose score for the final face region has the value less than the predefined minimum score.

Calculating the plurality of final face elements may further include, after firstly calculating the plurality of extracted face element candidates determining, by a second calculation unit, whether a condition that a difference between a distance between a left eye and a nose and a distance between a right eye and the nose, among the firstly calculated final face elements, has a value less than a predefined difference is satisfied, and then secondly calculating the plurality of extracted face element candidates included in the final face region as final face elements.

Calculating the plurality of final face elements may further include, after secondly calculating the plurality of extracted face element candidates, determining, by a third calculation unit, whether a condition that a difference between the distance between the left eye or right eye to the nose, among the secondly calculated final face elements, has a value greater than a distance between the nose and the mouth is satisfied, and then thirdly calculating the plurality of extracted face element candidates included in the final face region as final face elements.

Detecting the final frontal face may include projecting, by a position pattern acquisition unit, 3D coordinates of each of the plurality of calculated final face elements onto a 2D plane, and then acquiring a position pattern between the final face elements.

Detecting the final frontal face may further include, after acquiring the position pattern, determining, by a position pattern analysis unit, whether the acquired position pattern corresponds to a predefined reference pattern, and if the acquired position pattern corresponds to the reference pattern, detecting a final face region including the plurality of final face elements as a final frontal face.

Detecting the final frontal face may further include if the acquired position pattern does not correspond to the reference pattern, correcting, by a reference pattern correction unit, the reference pattern by generating a new reference pattern, wherein the new reference pattern is different from the reference pattern and is generated by adding new face elements that are both corners of the mouth.

In accordance with a further aspect of the present invention to accomplish the above objects, there is provided a frontal face detection method using a facial pose, including generating, by a new reference pattern generation unit, a new reference pattern by adding new face elements that are both corners of a mouth, extracting, by a new candidate extraction unit, new face element candidates from an input image, calculating, by a new face element calculation unit, a plurality of final face elements in correspondence with a facial pose score for a final face region including the extracted new face element candidates, the new face element candidates being generated based on a predefined average face model, and detecting, by a new final frontal face detection unit, a final frontal face from the final face region including the plurality of final face elements by comparing a position pattern between the final face elements with the new reference pattern.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a frontal face detection apparatus using a facial pose according to an embodiment of the present invention;

FIG. 2 is a diagram showing the candidate extraction unit of the frontal face detection apparatus using a facial pose according to the present invention;

FIG. 3 is a diagram showing the face element calculation unit of the frontal face detection apparatus using a facial pose according to the present invention;

FIG. 4 is a diagram showing the final frontal face detection unit of the frontal face detection apparatus using a facial pose according to the present invention;

FIG. 5 is a diagram showing a procedure for extracting face element candidates in the frontal face detection apparatus using a facial pose according to the present invention;

FIG. 6 is a diagram showing a relationship between the final face elements extracted by the frontal face detection apparatus using a facial pose according to the present invention;

FIG. 7 is a diagram showing a procedure for generating a location pattern via the frontal face detection apparatus using a facial pose according to the present invention;

FIG. 8 is a diagram showing a procedure for adding new face elements via the frontal face detection apparatus using a facial pose according to the present invention;

FIG. 9 is a flowchart showing a frontal face detection method using a facial pose according to the present invention;

FIGS. 10 and 11 are flowcharts showing a procedure for calculating final face elements in the frontal face detection method using a facial pose according to the present invention; and

FIG. 12 is a flowchart showing an embodiment of a frontal face detection method using a facial pose according to the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below.

The embodiments of the present invention are intended to fully describe the present invention to a person having ordinary knowledge in the art to which the present invention pertains. Accordingly, the shapes, sizes, etc. of components in the drawings may be exaggerated to make the description clearer.

Further, in the description of the components of the present invention, the terms such as first, second, A, B, (a), and (b) may be used. Such terms are merely intended to distinguish a specific component from other components and are not intended to limit the essential features, order, or sequential position of the corresponding component.

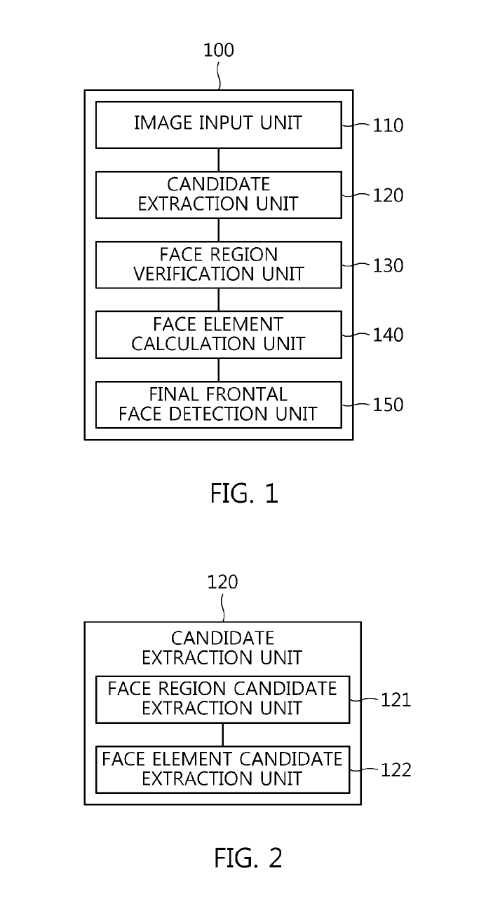

Hereinafter, a frontal face detection apparatus using a facial pose according to the present invention will be described in detail. FIG. 1 is a block diagram showing a frontal face detection apparatus using a facial pose according to the present invention.

Referring to FIG. 1, a frontal face detection apparatus 100 using a facial pose according to the present invention includes an image input unit 110, a candidate extraction unit 120, a face region verification unit 130, a face element calculation unit 140, and a final frontal face detection unit 150.

In detail, the image input unit 110 of the frontal face detection apparatus 100 using a facial pose according to the present invention receives an input image. The candidate extraction unit 120 extracts a face region candidate and face element candidates from the input image. The face region verification unit 130 verifies whether the extracted face region candidate is a final face region, based on a plurality of face element candidates extracted by the candidate extraction unit 120. The face element calculation unit 140 calculates a plurality of final face elements in correspondence with a facial pose score for the final face region including the plurality of extracted face element candidates that are generated based on a predefined average face model. The final frontal face detection unit 150 detects a final frontal face from the final face region including the plurality of final face elements, based on position patterns between the final face elements.

The image input unit 110 functions to receive an input image.

More specifically, the image input unit 110 functions to receive a target video in which a human face is to be detected. The video may be stored in a storage medium, and may be input through various methods such as streaming over the Internet.

The candidate extraction unit 120 functions to extract a face region candidate and face element candidates from the input image (video). FIG. 2 is a diagram showing the candidate extraction unit of the frontal face detection apparatus using a facial pose according to the present invention.

Referring to FIG. 2, the candidate extraction unit 120 may include a face region candidate extraction unit 121 and a face element candidate extraction unit 122.

In this case, the face region candidate extraction unit 121 functions to extract a face region candidate depending on previously learned face detection data. The face element candidate extraction unit 122 functions to extract face element candidates including a left eye, a right eye, a nose, and a mouth depending on previously learned face element detection data.

In detail, the face region candidate extraction unit 121 determines whether a region corresponding to the previously learned face detection data is present in the input image, through a face detector that uses the previously learned face detection data, and if the region corresponding to the face detection data is present in the input image, extracts the corresponding region as the face region candidate.

The term “face region candidate” does not mean a final face region which is a finally verified face region. In order to verify the face region candidate as the final face region, verification by the face region verification unit 130 is performed.

A detailed technical configuration of the face region verification unit 130 will be described later.

Further, by means of a face element detector that uses previously learned face element detection data (eye detection data, nose detection data, and mouth detection data), the face element candidate extraction unit 122 determines whether a portion corresponding to the previously learned face element detection data is present in the input image, and if the portion corresponding to the face element detection data is present in the input image, extracts the corresponding portion as face element candidates. That is, the face element candidates may include, in detail, eye candidates, mouth candidates, nose candidates, etc.

The term “face element candidate” does not mean a final face element which is a finally calculated face element. In order for face element candidates to be calculated as the final face elements, a multi-step procedure (first calculation to third calculation) must be performed by the face element calculation unit 140. A detailed technical configuration of the face element calculation unit 140 will be described later.

The face region verification unit 130 functions to verify whether the extracted face region candidate is a final face region, based on the plurality of face element candidates extracted by the candidate extraction unit 120.

In detail, in order for the detected face region candidate to be the final face region, the detected face region candidate must include all essential face element candidates.

In greater detail, the face region candidate may be verified to be the final face region only when the face region candidate includes a plurality of face element candidates corresponding to eyes (left eye and right eye), nose, and mouth.

That is, if even one face element candidate is not detected, it is determined that the face region candidate is not a face, and thus the face region candidate is not fixed as a final face region.

This is a method for improving precision because, when a face is extracted only by the face region candidate extraction unit 121 (e.g., a face detector), a background image having a pattern similar to a face pattern may be erroneously determined to be a face image.

The face element calculation unit 140 functions to calculate a plurality of final face elements in correspondence with a facial pose score for the final face region that includes the plurality of extracted face element candidates generated based on a predefined average face model.

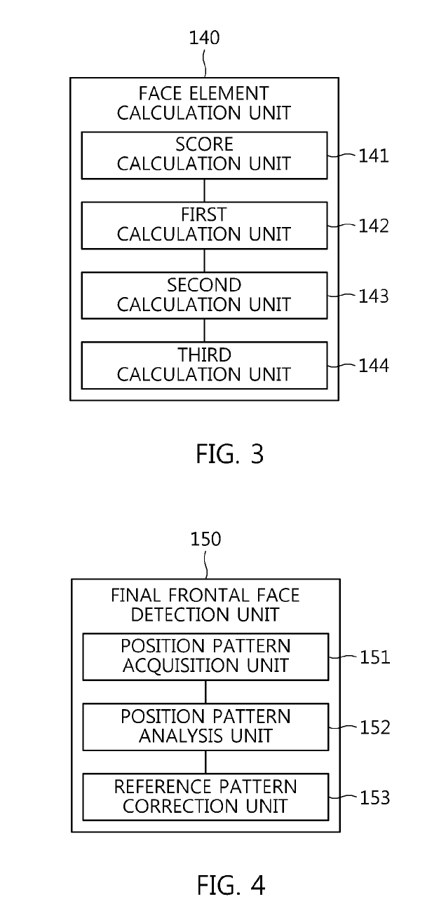

FIG. 3 is a diagram showing the face element calculation unit of the frontal face detection apparatus using a facial pose according to the present invention.

Referring to FIG. 3, the face element calculation unit 140 of the frontal face detection apparatus using a facial pose according to the present invention includes a score calculation unit 141, a first calculation unit 142, a second calculation unit 143, and a third calculation unit 144.

More specifically, the score calculation unit 141 functions to calculate a facial pose score for the final face region based on 3D coordinates of the plurality of extracted face element candidates which are generated by matching the final face including the plurality of extracted face element candidates with the predefined average face model.

In this case, the facial pose score is obtained by assigning different weights to rotation angles of the final face region in the directions of X, Y, and Z axes and the distance between the final face region and the camera, respectively, and summing up resulting values.

Here, the term “average face model” denotes the coordinates of predefined face elements in a 3D space, based on Dementhon and Davis's methods stated in the related art, and 3D coordinates of each of a plurality of face element candidates are acquired by mapping a plurality of 2D extracted face element candidates to the average face model.

A detailed method for calculating the facial pose score is represented by the following Equation (1):

Sₚ=w₁θₓ+w₂θ_{y}+w₃θ_{z}+w₄t_{z} (1)

where Sₚ denotes a facial pose score, w₁, w₂, w₃ and w₄ denote weights, θₓ denotes a variation in the angle of an object with respect to an X axis, θ_{y} denotes a variation in the angle of the object with respect to a Y axis, and θ_{z} denotes a variation in the angle of the object with respect to a Z axis.

Further, t_{z} denotes a distance between the camera and the object. That is, it can be determined whether a target object is located close to or far from the camera with respect to the Z axis.

The term “object” denotes the center of a 3D face formed as the 3D coordinates of each of the plurality of 2D face element candidates are generated by mapping the 2D extracted face element candidates to the average face model.

The first calculation unit 142 functions to determine whether the facial pose score for the final face region has a value less than a predefined minimum score, and to firstly calculate the plurality of extracted face element candidates, included in the final face region, as final face elements if the facial pose score for the final face region has the value less than the predefined minimum score.

More specifically, this operation is performed based on the fact that the optimal facial pose image, easy for face recognition, is a face image, the pose angle of which is close to 0° with respect to three axes (X, Y, and Z axes) and which is closest to the camera.

Therefore, as the facial pose score is lower, an optimal facial pose image easy for face recognition is generated. That is, the plurality of extracted face element candidates included in the final face region are firstly calculated as the final face elements only when the facial pose score has a value less than a predefined threshold, that is, the minimum score.

The second calculation unit 143 functions to determine whether a condition that a difference between a distance between a left eye and a nose and a distance between a right eye and the nose, among the final face elements which are firstly calculated by the first calculation unit 142, has a value less than a predefined difference is satisfied, and then secondly calculate the plurality of extracted face element candidates included in the final face region as final face elements.

In detail, even if the final face elements are calculated by the first calculation unit 142, the face element candidates are secondly determined to improve precision.

The third calculation unit 144 functions to determine whether a condition that a difference between the distance between the left eye or right eye and the nose, among the final face elements secondly calculated by the second calculation unit 143, has a value greater than a distance between the nose and the mouth is satisfied, and then thirdly calculate the plurality of extracted face element candidates included in the final face region as final face elements.

In detail, even if the final face elements have been calculated by the first calculation unit 142 and the second calculation unit 143, the face element candidates are thirdly determined so as to improve the precision of calculation.

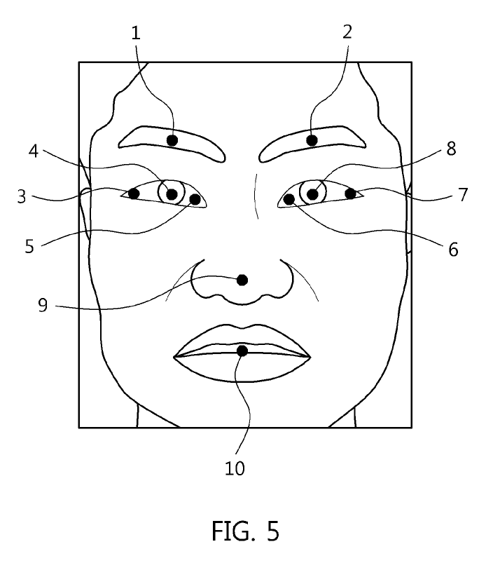

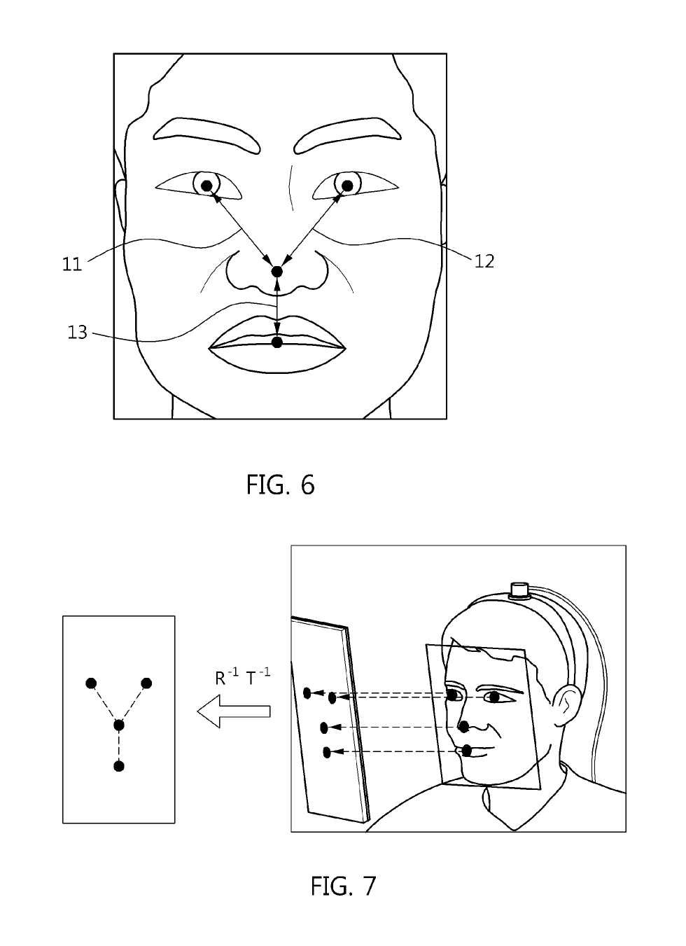

FIG. 5 is a diagram showing a procedure for extracting face element candidates in the frontal face detection apparatus using a facial pose according to the present invention. FIG. 6 is a diagram showing a relationship between the final face elements extracted by the frontal face detection apparatus using a facial pose according to the present invention.

Referring to FIGS. 5 and 6, as the face element candidates extracted by the candidate extraction unit 120, a plurality of eye candidates 1, 2, 3, 4, 5, 6, 7, and 8, a nose candidate 9, and a mouth candidate 10 are present. That is, the case where the end points of two eyes and eyebrows, as well as two eyes, are detected as eye candidates depending on input images may occur.

Here, among the plurality of eye candidates 1, 2, 3, 4, 5, 6, 7, and 8, the final face elements are calculated through the first calculation unit 142, the second calculation unit 143, and the third calculation unit 144. Referring to FIG. 6, the final face elements determined in consideration of the results of the calculation by the second calculation unit 143 and the third calculation unit 144 can be seen.

In detail, since a distance 11 between the left eye and the nose must be similar to a distance 12 between the right eye and the nose, the second calculation unit 143 determines whether a difference between the distance 11 between the left eye and the nose and the distance 12 between the right eye and the nose has a value less than a predefined difference, and then secondly calculates final face elements if the above condition is satisfied.

Further, the third calculation unit 144 thirdly calculates final face elements only when, in consideration of the fact that the distance 11 or 12 between the left eye or the right eye and the nose must be greater than a distance 13 between the nose and the mouth, the distance 11 or 12 between the left eye or the right eye and the nose is greater than the distance 13 between the nose and the mouth.

The above-described face element calculation unit 140 may be configured such that the sequence of the operations of the first calculation unit 142, the second calculation unit 143, and the third calculation unit 144 is changed. The first calculation unit 142, the second calculation unit 143, and the third calculation unit 144 may be configured to be selectively combined.

Below, the final frontal face detection unit 150 of the frontal face detection apparatus 100 using a facial pose according to the present invention will be described in detail.

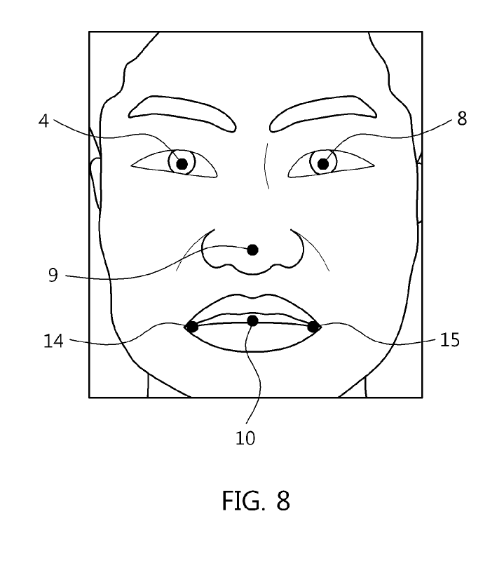

FIG. 4 is a diagram showing the final frontal face detection unit of the frontal face detection apparatus using a facial pose according to the present invention. FIG. 7 is a diagram showing a procedure for generating a location pattern via the frontal face detection apparatus using a facial pose according to the present invention. FIG. 8 is a diagram showing a procedure for adding new face elements via the frontal face detection apparatus using a facial pose according to the present invention.

The final frontal face detection unit 150 functions to detect a final frontal face from a final face region including a plurality of final face elements, based on a position pattern between the final face elements.

Referring to FIG. 4, the final frontal face detection unit 150 may include a position pattern acquisition unit 151, a position pattern analysis unit 152, and a reference pattern correction unit 153.

In detail, the position pattern acquisition unit 151 functions to acquire a position pattern between the final face elements by projecting 3D coordinates of each of the final face elements calculated by the face element calculation unit onto a 2D plane.

Referring to FIG. 7, it can be seen that the 3D coordinates of the respective final face elements are projected onto the 2D plane.

When the shapes of patterns acquired at this time are observed, it can be seen that a Y-shaped pattern is projected. That is, the positions of eyes, nose, and mouth have a Y-shaped structure such as that projected from the frontal face.

Further, the position pattern analysis unit 152 functions to determine whether the position pattern acquired by the position pattern acquisition unit 151 corresponds to a reference pattern that is a preset pattern, and to detect the final face region including the plurality of final face elements as a final frontal face if the acquired position pattern corresponds to the reference pattern.

In detail, when the acquired pattern is a Y-shaped pattern, the final face region including the plurality of final face elements is detected as the final frontal face.

Further, the reference pattern correction unit 153 functions to correct the reference pattern by generating a new reference pattern different from the reference pattern in such a way as to add new face elements, which are both end portions (corners) of the mouth, to the reference pattern if the acquired position pattern does not correspond to the reference pattern.

More specifically, if the acquired pattern is not a Y-shaped pattern, a facial pose score is recalculated by adding new facial feature points.

In this case, the new facial feature points may be both mouth corners, as shown in FIG. 6.

That is, whether the facial pose score newly generated by recalculating the facial pose score has a value less than the predefined minimum score is re-determined A final face image is extracted based on a new pattern (pattern other than the Y-shaped pattern) into which the new facial feature points are incorporated.

The frontal face detection apparatus 100 using a facial pose according to the present invention repeatedly detects a final frontal face per frame of a video, selects each final face image having the lowest facial pose score, and stores the selected final face image in a storage medium. Therefore, an optimal frontal face is detected from a single video file.

Hereinafter, a frontal face detection method using a facial pose according to the present invention will be described in detail. Repeated descriptions of the technical configuration identical to that of the frontal face detection apparatus 100 using a facial pose according to the present invention will be omitted.

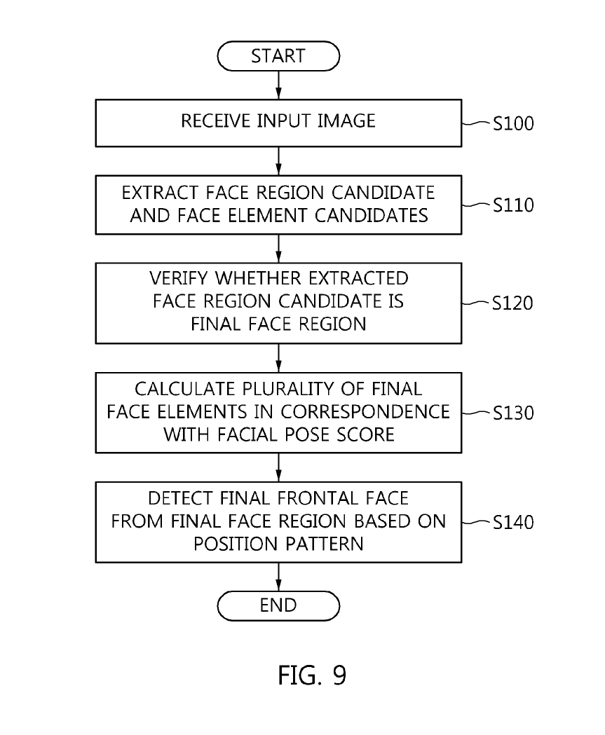

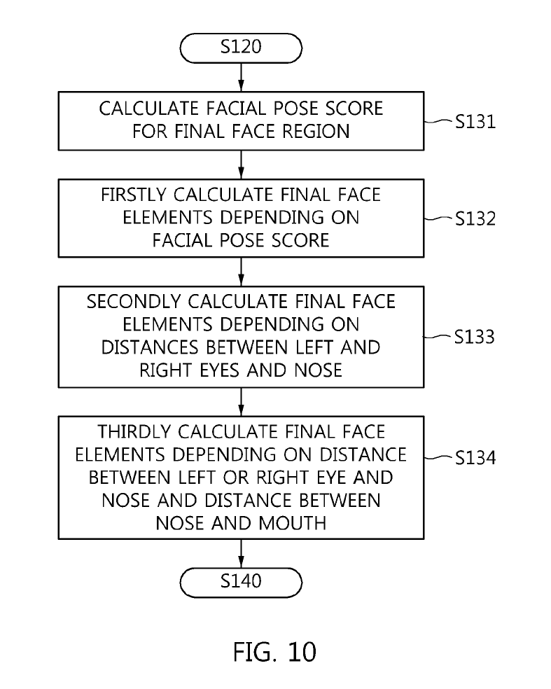

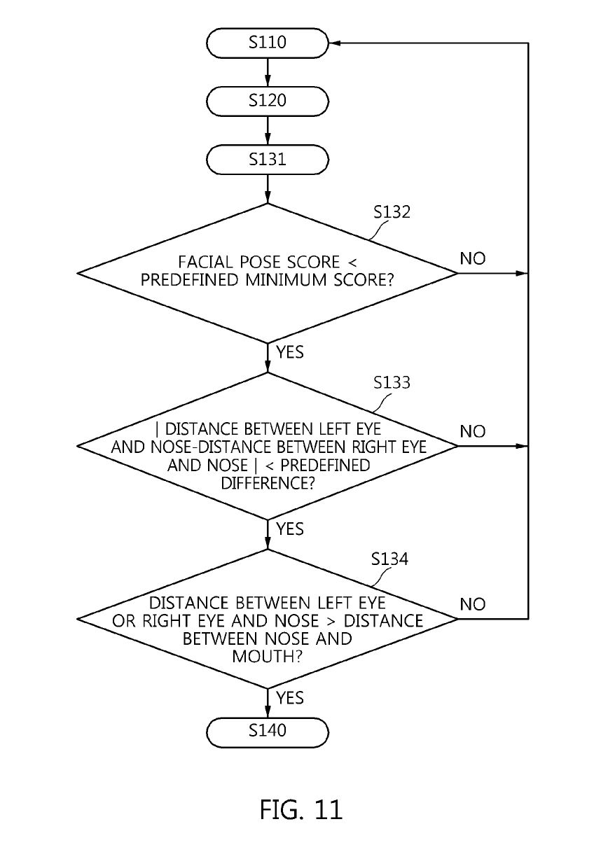

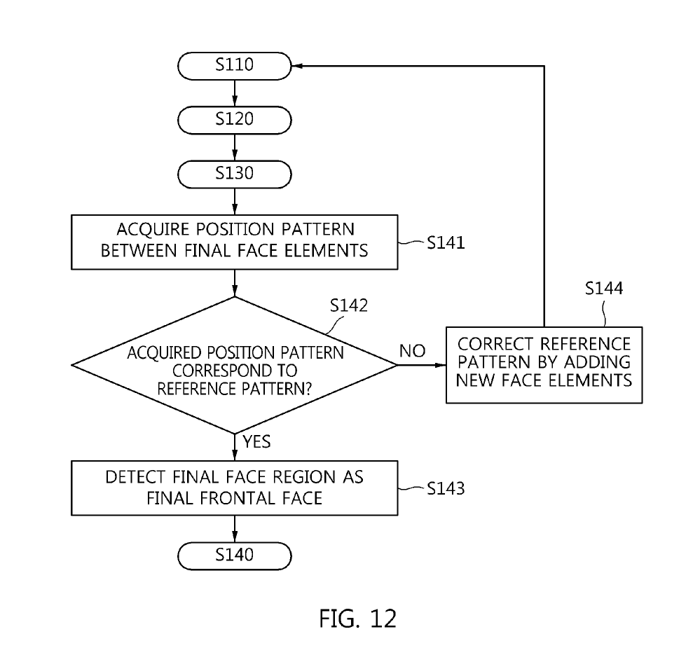

FIG. 9 is a flowchart showing a frontal face detection method using a facial pose according to the present invention. FIGS. 10 and 11 are flowcharts showing a procedure for calculating final face elements in the frontal face detection method using a facial pose according to the present invention. FIG. 12 is a flowchart showing an embodiment of a frontal face detection method using a facial pose according to the present invention.

Referring to FIG. 9, the frontal face detection method using a facial pose according to the present invention includes steps S100 to S140. At step S100, by the image input unit, an input image is received. At step S110, by the candidate extraction unit, a face region candidate and face element candidates are extracted from the input image. At step S120, by the face region verification unit, it is verified whether the extracted face region candidate is a final face region, based on the plurality of face element candidates extracted at the extraction step. At step S130, by the face element calculation unit, a plurality of final face elements are calculated in correspondence with a facial pose score for the final face region including the plurality of extracted face element candidates generated based on a predefined average face model. At step S140, by the final frontal face detection unit, a final frontal face is detected from the final face region including the plurality of final face elements, based on a position pattern between the final face elements.

An embodiment of step S130 is described in detail with reference to FIG. 10. After step S120, a facial pose score for the final face region is calculated at step S131. Thereafter, the final face elements are firstly calculated depending on the facial pose score at step S132. Final face elements are secondly calculated depending on the distances between the left and right eyes and the nose at step S133. Final face elements are thirdly calculated depending on the distance between the left eye or the right eye and the nose and the distance between the nose and the mouth at step S134. Thereafter, the process proceeds to step S140.

When the embodiment of step S130 is described in detail with reference to FIG. 11, the process proceeds to step S120 after step S110 has been performed, and then proceeds to step S131 where a facial pose score for the final face region is calculated after step S120 has been performed.

In this case, it is determined at step S132 whether the facial pose score has a value less than a predefined minimum score. If it is determined that the facial pose score has a value equal to or greater than the predefined minimum score, the process returns to step S110 where face element candidates are extracted again.

In contrast, if it is determined at step S132 that the facial pose score has a value less than the predefined minimum score, the process proceeds to step S133. In this case, it is determined whether a difference between the distance between the left eye and the nose and the distance between the right eye and the nose has a value less than a predefined difference. Typically, it is premised that the distance between the left eye and the nose is similar to the distance between the right eye and the nose. More specifically, if the difference between the distance between the left eye and the nose and the distance between the right eye and the nose is not less than the predefined difference, that is, if the distance between the left eye and the nose and the distance between the right eye and the nose are different from each other by a predetermined range or more, the process returns to step S110 where face element candidates are re-extracted.

In contrast, if it is determined that the difference between the distance between the left eye and the nose and the distance between the right eye and the nose has a value less than the predefined difference, the process proceeds to step S134 where it is determined whether the distance between the left eye or the right eye and the nose is greater than a distance between the nose and the mouth. Typically, this operation is performed on the assumption that the difference between the eye and the nose is greater than the distance between the nose and the mouth.

More specifically, if the distance between the left eye or the right eye and the nose is less than or equal to the distance between the nose and the mouth, the process returns to the step S110 of re-extracting face element candidates, whereas if the distance between the left eye or the right eye and the nose is greater than the distance between the nose and the mouth, the process proceeds to step S140.

In this way, final face elements may be more precisely calculated via the three-step calculations of face elements at steps S132, S133, and S134.

An embodiment of the frontal face detection method using a facial pose according to the present invention will be described in detail with reference to FIG. 12. The process proceeds to step S120 after step S110 has been performed, and proceeds to step S141 where a position pattern between the final face elements is acquired after step S130 has been performed.

That is, if the final face elements are fixed at step S130, a position pattern between the final face elements is acquired based on the fixed final face elements. A detailed method of acquiring the position pattern has been described above.

Thereafter, the process proceeds to step S142 where it is determined whether the acquired position pattern corresponds to a reference pattern. If it is determined at step S142 that the acquired position pattern does not correspond to the reference pattern, the process proceeds to step S144 where the reference pattern is corrected by adding new face elements. Thereafter, the process returns to step S110 where face element candidates are newly extracted in correspondence with the added new face elements.

In contrast, if it is determined at step S142 that the acquired position pattern corresponds to the reference pattern, the final face region is detected as a final frontal face at step S143.

In detail, the final face region including the plurality of final face elements is detected as the final frontal face.

Another embodiment of a frontal face detection method using a facial pose according to the present invention includes the following steps. In detail, by a new reference pattern generation unit, a new reference pattern is generated by adding new face elements corresponding to both end portions of the mouth (mouth corners). By a new candidate extraction unit, new face element candidates are extracted from an input image. By a new face element calculation unit, a plurality of final face elements are calculated in correspondence with a facial pose score for a final face region including the extracted new face element candidates which are generated based on a predefined average face model. By a new final frontal face detection unit, a final frontal face is detected from the final face region including the plurality of final face elements by comparing a position pattern between the final face elements with the new reference pattern.

As described above, when the acquired position pattern does not correspond to the reference pattern, new face elements are added, with the result that a final frontal face is detected using a new reference.

In detail, as the new face elements, both corners of the mouth may be used. Therefore, if the new face elements are taken into consideration, the left eye, right eye, nose, mouth, the left corner of the mouth, and the right corner of the mouth may be feature points of the face, thus enabling the face to be more precisely extracted.

As described above, in accordance with the frontal face detection apparatus and method using a facial pose according to the present invention, there are advantages in that an optimal frontal face image easy for recognition can be extracted from input images by detecting a face image from a captured image, extracting facial feature points from the detected face image, and estimating a facial pose based on the extracted facial feature points, and in that the extraction results of face elements are examined after a face has been detected, it is determined whether the face image is authentic, the extracted face elements are verified and corrected, and a facial pose can be corrected after the facial pose has been estimated.

As described above, in the frontal face detection apparatus method and apparatus according to the present invention, the configurations and schemes in the above-described embodiments are not limitedly applied, and some or all of the above embodiments can be selectively combined and configured so that various modifications are possible.

What is claimed is:

1. A frontal face detection apparatus using a facial pose, comprising:
an image input unit for receiving an input image;
a candidate extraction unit for extracting a face region candidate and face element candidates from the input image;
a face region verification unit for verifying, based on a plurality of face element candidates extracted by the candidate extraction unit, whether the extracted face region candidate is a final face region;
a face element calculation unit for calculating a plurality of final face elements in correspondence with a facial pose score for a final face region including the plurality of extracted face element candidates generated based on a predefined average face model; and
a final frontal face detection unit for detecting a final frontal face from the final face region including the plurality of final face elements, based on a position pattern between the final face elements.

2. The frontal face detection apparatus of claim 1, wherein the candidate extraction unit comprises:
a face region candidate extraction unit for extracting a face region candidate depending on previously learned face detection data; and
a face element candidate extraction unit for extracting face element candidates including a left eye, a right eye, a nose, and a mouth depending on previously learned face element detection data.

3. The frontal face detection apparatus of claim 1, wherein the face region verification unit is configured to, when the face region candidate extracted by the candidate extraction unit includes a left eye, a right eye, a nose and a mouth, determine that the extracted face region candidate is a final face region, thus verifying the extracted face region candidate.

4. The frontal face detection apparatus of claim 1, wherein:
the face element calculation unit comprises a score calculation unit for calculating a facial pose score for the final face region based on three-dimensional (3D) coordinates of each of the plurality of extracted face element candidates which are generated by matching a final face including the plurality of extracted face element candidates with a predefined average face model, and
the facial pose score is a value obtained by assigning different weights to rotation angles of the final face region in directions of X, Y, and Z axes and a distance between the final face region and a camera, respectively, and summing up resulting values.

5. The frontal face detection apparatus of claim 4, wherein the face element calculation unit comprises a first calculation unit for determining whether the facial pose score for the final face region has a value less than a predefined minimum score, and then firstly calculating the plurality of extracted face element candidates, included in the final face region, as final face elements if the facial pose score for the final face region has the value less than the predefined minimum score.

6. The frontal face detection apparatus of claim 5, wherein the face element calculation unit further comprises a second calculation unit for determining whether a condition that a difference between a distance between a left eye and a nose and a distance between a right eye and the nose, among the final face elements firstly calculated by the first calculation unit, has a value less than a predefined difference is satisfied, and then secondly calculating the plurality of extracted face element candidates included in the final face region as final face elements.

7. The frontal face detection apparatus of claim 6, wherein the face element calculation unit further comprises a third calculation unit for determining whether a condition that a difference between the distance between the left eye or right eye and the nose, among the final face elements secondly calculated by the second calculation unit, is greater than a distance between the nose and the mouth is satisfied, and then thirdly calculating the plurality of extracted face element candidates included in the final face region as final face elements.

8. The frontal face detection apparatus of claim 1, wherein the final frontal face detection unit comprises a position pattern acquisition unit for projecting three-dimensional (3D) coordinates of each of the plurality of final face elements calculated by the face element calculation unit onto a 2D plane, and then acquiring a position pattern between the final face elements.

9. The frontal face detection apparatus of claim 8, wherein the final frontal face detection unit further comprises a position pattern analysis unit for determining whether the position pattern acquired by the position pattern acquisition unit corresponds to a predefined reference pattern, and if the acquired position pattern corresponds to the reference pattern, detecting a final face region including the plurality of final face elements as a final frontal face.

10. The frontal face detection apparatus of claim 9, wherein the final frontal face detection unit further comprises a reference pattern correction unit for, if the acquired position pattern does not correspond to the reference pattern, correcting the reference pattern by generating a new reference pattern, wherein the new reference pattern is different from the reference pattern and is generated by adding new face elements that are both corners of the mouth.

11. A frontal face detection method using a facial pose, comprising:
receiving, by an image input unit, an input image;
extracting, by a candidate extraction unit, a face region candidate and face element candidates from the input image;
verifying, by a face region verification unit, whether the extracted face region candidate is a final face region, based on a plurality of extracted face element candidates;
calculating, by a face element calculation unit, a plurality of final face elements in correspondence with a facial pose score for a final face region including the plurality of extracted face element candidates generated based on a predefined average face model; and
detecting, by a final frontal face detection unit, a final frontal face from the final face region including the plurality of final face elements, based on a position pattern between the final face elements.

12. The frontal face detection method of claim 11, wherein verifying whether the extracted face region candidate is the final face region comprises, when the extracted face region candidate includes a left eye, a right eye, a nose and a mouth, determining that the extracted face region candidate is a final face region, thus verifying the extracted face region candidate.

13. The frontal face detection method of claim 11, wherein calculating the plurality of final face elements comprises:
calculating, by a score calculation unit, a facial pose score for the final face region based on three-dimensional (3D) coordinates of each of the plurality of extracted face element candidates which are generated by matching a final face including the plurality of extracted face element candidates with a predefined average face model, and
the facial pose score is a value obtained by assigning different weights to rotation angles of the final face region in directions of X, Y, and Z axes and a distance between the final face region and a camera, respectively, and summing up resulting values.

14. The frontal face detection method of claim 13, wherein calculating the plurality of final face elements comprises:
determining, by a first calculation unit, whether the facial pose score for the final face region has a value less than a predefined minimum score, and then firstly calculating the plurality of extracted face element candidates, included in the final face region, as final face elements if the facial pose score for the final face region has the value less than the predefined minimum score.

15. The frontal face detection method of claim 14, wherein calculating the plurality of final face elements further comprises, after firstly calculating the plurality of extracted face element candidates:
determining, by a second calculation unit, whether a condition that a difference between a distance between a left eye and a nose and a distance between a right eye and the nose, among the firstly calculated final face elements, has a value less than a predefined difference is satisfied, and then secondly calculating the plurality of extracted face element candidates included in the final face region as final face elements.

16. The frontal face detection method of claim 15, wherein calculating the plurality of final face elements further comprises, after secondly calculating the plurality of extracted face element candidates:
determining, by a third calculation unit, whether a condition that a difference between the distance between the left eye or right eye to the nose, among the secondly calculated final face elements, has a value greater than a distance between the nose and the mouth is satisfied, and then thirdly calculating the plurality of extracted face element candidates included in the final face region as final face elements.

17. The frontal face detection method of claim 11, wherein detecting the final frontal face comprises:
projecting, by a position pattern acquisition unit, 3D coordinates of each of the plurality of calculated final face elements onto a 2D plane, and then acquiring a position pattern between the final face elements.

18. The frontal face detection method of claim 17, wherein detecting the final frontal face further comprises, after acquiring the position pattern:
determining, by a position pattern analysis unit, whether the acquired position pattern corresponds to a predefined reference pattern, and if the acquired position pattern corresponds to the reference pattern, detecting a final face region including the plurality of final face elements as a final frontal face.

19. The frontal face detection method of claim 18, wherein detecting the final frontal face further comprises:
if the acquired position pattern does not correspond to the reference pattern, correcting, by a reference pattern correction unit, the reference pattern by generating a new reference pattern, wherein the new reference pattern is different from the reference pattern and is generated by adding new face elements that are both corners of the mouth.

20. A frontal face detection method using a facial pose, comprising:
generating, by a new reference pattern generation unit, a new reference pattern by adding new face elements that are both corners of a mouth;
extracting, by a new candidate extraction unit, new face element candidates from an input image;
calculating, by a new face element calculation unit, a plurality of final face elements in correspondence with a facial pose score for a final face region including the extracted new face element candidates, the new face element candidates being generated based on a predefined average face model; and
detecting, by a new final frontal face detection unit, a final frontal face from the final face region including the plurality of final face elements by comparing a position pattern between the final face elements with the new reference pattern.
